(19) United States
(12) Patent Application Publication
(10) Pub. No.: US 2023/0169769 A1
(43) Pub. Date: Jun. 1, 2023

(54) IMAGE PROCESSING SYSTEM

(71) Applicant: TOYOTA JIDOSHA KABUSHIKI KAISHA, Toyota-shi (JP)

(72) Inventors: Masahiro MORI, Nisshin-shi (JP); Takahiro FUJITA, Toyota-shi (JP)

(73) Assignee: TOYOTA JIDOSHA KABUSHIKI KAISHA, Toyota-shi (JP)

(21) Appl. No.: 17/948,471

(22) Filed: Sep. 20, 2022

(30) Foreign Application Priority Data
Nov. 30, 2021 (JP) 2021-193954

(51) Int. Cl. G06V 20/40; G06V 20/54; G06V 10/82; G06T 7/194

(52) U.S. Cl. CPC G06V 20/46; G06V 20/54; G06V 10/82; G06T 7/194; G06V 2201/07; G06V 2201/08; G06T 2207/20081; G06T 2207/20084; G06T 2207/20132; G06T 2207/30236

(57) ABSTRACT

An image processing system includes: a memory configured to store moving image data photographed by a camera; and a processor configured to perform image processing on the moving image data stored in the memory, extract a plurality of frames in which a target vehicle registered in advance is imaged from a moving image photographed by the camera, and select a frame in which the target vehicle is positioned at a specific position among the frames.

### CROSS-REFERENCE TO RELATED APPLICATION

This application claims priority to Japanese Patent Application No. 2021-193954 filed on Nov. 30, 2021, incorporated herein by reference in its entirety.

### BACKGROUND

### 1. Technical Field

The present disclosure relates to an image processing system.

### 2. Description of Related Art

A user who likes to drive may have a desire (need) to photograph the appearance of the traveling vehicle of the user. The user can post (upload) a photographed image to, for example, a social networking service (hereinafter referred to as “SNS”), such that many people can see the photographed image. Note that, it is difficult for the user to photograph the appearance of the traveling vehicle while the user drives. Therefore, a service that photographs the appearance of the traveling vehicle has been proposed. For example, Japanese Unexamined Patent Application Publication No. 2019-121319 (JP 2019-121319 A) discloses a vehicle photographing support device.

### SUMMARY

The vehicle photographing support device described in JP 2019-121319 A includes a specification unit that specifies an external camera configured to photograph a vehicle in a traveling state from the outside, an instruction unit that instructs the external camera specified by the specification unit to photograph the vehicle in a traveling state, and an acquisition unit that acquires a photographed image obtained by the external camera in response to an instruction by the instruction unit.

Further, the vehicle photographing support device further includes a reception unit that receives photographing request information input from the user, and the photographing request information includes, for example, information about an editing pattern specified by the user.

Note that, the user cannot know in advance what kind of image can be acquired from the photographed image photographed by the external camera, and there is a possibility that the editing pattern specified by the user does not result in an attractive image.

The present disclosure provides an image processing system capable of acquiring an attractive image of a traveling vehicle.

An image processing system according to the present disclosure includes a memory configured to store moving image data photographed by a camera, and a processor configured to perform image processing on the moving image data stored in the memory, extract a plurality of frames in which a target vehicle registered in advance is imaged from a moving image photographed by the camera, and select a frame in which the target vehicle is positioned at a specific position among the frames.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing an overall configuration of an image processing system according to a present embodiment;

FIG. 2 is a block diagram showing a typical hardware configuration of a photographing system;

FIG. 3 is a first view (perspective view) showing a state of vehicle photographing by the photographing system;

FIG. 4 is a second view (top view) showing a state of vehicle photographing by the photographing system;

FIG. 5 is a diagram showing an example of one frame of an identification moving image;

FIG. 6 is a diagram showing an example of one frame of a viewing moving image;

FIG. 7 is a block diagram showing a typical hardware configuration of a server;

FIG. 8 is a functional block diagram showing a functional configuration of the photographing system and the server;

FIG. 9 is a diagram schematically showing specific positions P1, P2, P3 in one frame of a moving image photographed by a viewing moving image photographing unit;

FIG. 10 is an extraction image IM1 in which a target vehicle is positioned at the specific position P1;

FIG. 11 is an extraction image IM2 in which the target vehicle is positioned at the specific position P2;

FIG. 12 is an extraction image IM3 in which the target vehicle is positioned at the specific position P3;

FIG. 13 is the extraction image IM1 schematically showing a result of analysis by using an object detection model;

FIG. 14 is a diagram schematically showing a state in which a rule of thirds map CM1 is superimposed on the extraction image IM1 showing a target range R1 and the like;

FIG. 15 is a diagram showing a rule of thirds map CM1 and the like;

FIG. 16 is a diagram showing a final image FIM1;

FIG. 17 is the extraction image IM2 schematically showing a result of analysis by using the object detection model;

FIG. 18 is a diagram showing a state in which a center composition map CM2 is superimposed on the extraction image IM2 showing the target range R1 and the like;

FIG. 19 is a diagram schematically showing a final image FIM2;

FIG. 20 is a diagram showing a state in which a rule of thirds map CM3 is superimposed on the extraction image IM3 while the extraction image IM3 is analyzed by using the object detection model;

FIG. 21 is a diagram showing the rule of thirds map CM3 and the like;

FIG. 22 is a diagram showing a final image FIM3;

FIG. 23 is a diagram for describing an example of a trained model (vehicle extraction model) used in vehicle extraction processing;

FIG. 24 is a diagram for describing an example of a trained model (number recognition model) used in number recognition processing;

FIG. 25 is a diagram for describing an example of a trained model (target vehicle specification model) used in target vehicle specification processing;

FIG. 26 is a diagram for describing an example of a trained model (frame extraction model) that extracts a frame;

FIG. 27 is a diagram for describing an example of a trained model (vehicle cropping model) that extracts a frame; and

FIG. 28 is a flowchart showing a processing procedure of photographing processing of the vehicle according to the present embodiment.

### DETAILED DESCRIPTION OF EMBODIMENTS

Hereinafter, embodiments of the present disclosure will be described in detail with reference to the drawings. The same or corresponding parts in the drawings are designated by the same reference numerals, and the description thereof will not be repeated.

### Embodiment

System Configuration

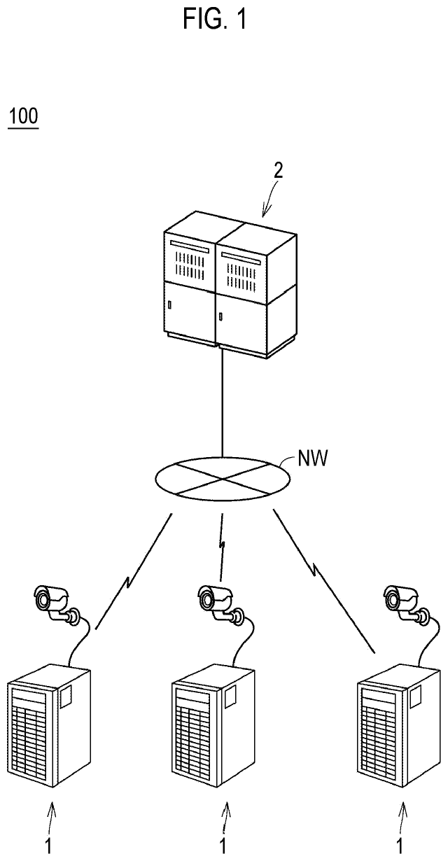

FIG. 1 is a diagram schematically showing an overall configuration of an image processing system according to a present embodiment. An image processing system 100 includes a plurality of photographing systems 1 and a server 2. Each of the photographing systems 1 and the server 2 are connected to each other to be able to communicate with each other via a network NW. Although the three photographing systems 1 are shown in FIG. 1, the number of the photographing systems 1 is not particularly limited. There may be merely the one photographing system 1.

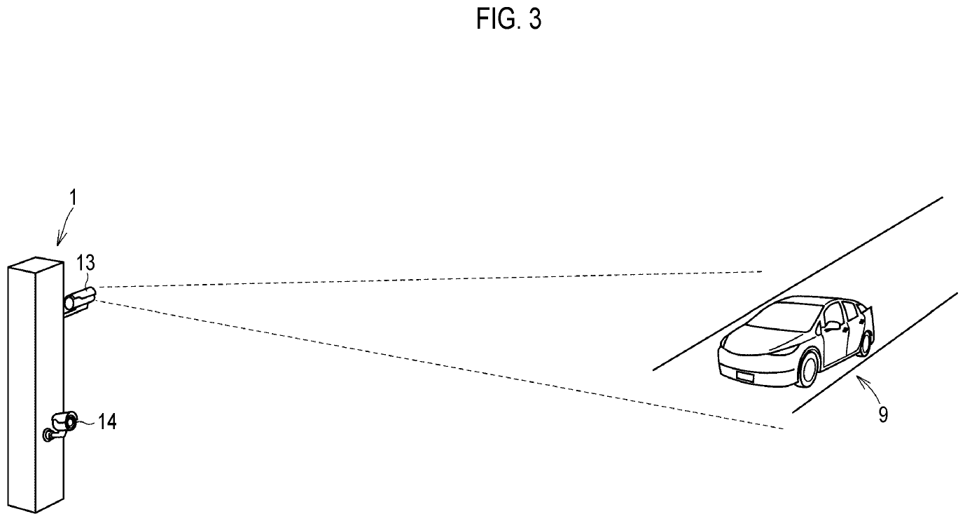

The photographing system 1 is installed, for example, near a road, and photographs a vehicle 9 (see FIG. 3) traveling on the road. In the present embodiment, the photographing system 1 performs a predetermined arithmetic processing (described later) on the photographed moving image, and transmits the arithmetic processing result to the server 2 together with the moving image.

The server 2 is, for example, an in-house server of a business operator that provides a vehicle photographing service. The server 2 may be a cloud server provided by a cloud server management company. The server 2 generates an image for a user to view (hereinafter, also referred to as “viewing image”) from the moving image received from the photographing system 1, and provides the generated viewing image to the user. The viewing image is generally a still image, but may be a short moving image. The user is often the driver of the vehicle 9, but is not particularly limited.

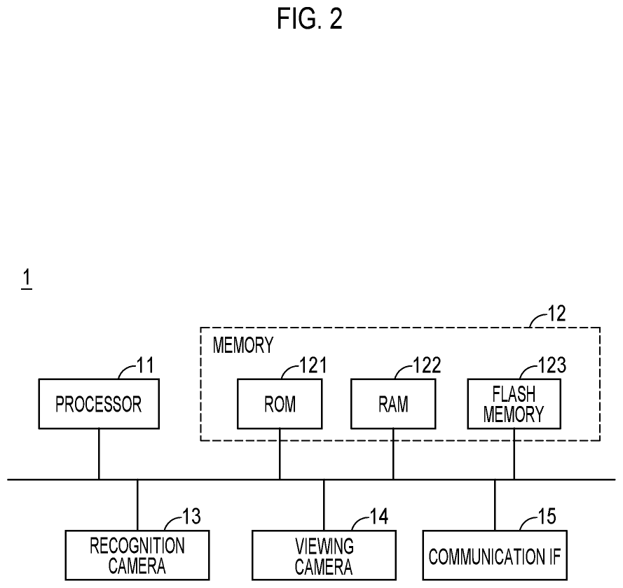

FIG. 2 is a block diagram showing a typical hardware configuration of the photographing system 1. The photographing system 1 includes a processor 11, a memory 12, a recognition camera 13, a viewing camera 14, and a communication interface (IF) 15. The memory 12 includes a read only memory (ROM) 121, a random access memory (RAM) 122, and a flash memory 123. The components of the photographing system 1 are connected to each other by a bus and the like.

The processor 11 controls the overall operation of the photographing system 1. The memory 12 stores a program (an operating system and an application program) executed by the processor 11 and data (a map, a table, a mathematical formula, a parameter, and the like) used in the program. Further, the memory 12 temporarily stores the moving image photographed by the photographing system 1.

The recognition camera 13 photographs a moving image (hereinafter, also referred to as “identification moving image”) for the processor 11 to recognize the number of the license plate provided on the vehicle 9. The viewing camera 14 photographs a moving image (hereinafter, also referred to as “viewing moving image”) used for generating the viewing image. Each of the recognition camera 13 and the viewing camera 14 is desirably a high-sensitivity kind camera with a polarizing lens.

The communication IF 15 is an interface for communicating with the server 2. The communication IF 15 is, for example, a communication module compliant with 4G (Generation) or 5G.

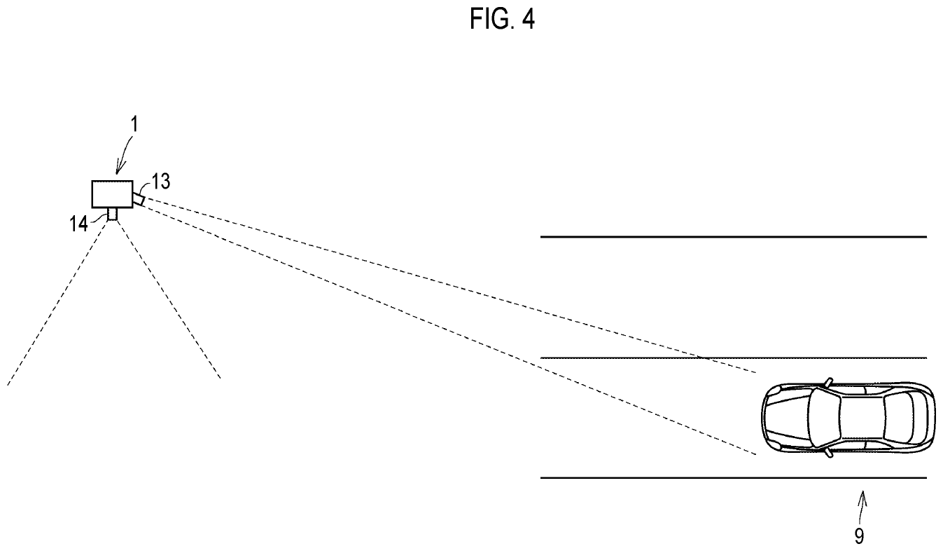

FIG. 3 is a first view (perspective view) showing a state of vehicle photographing by the photographing system 1. FIG. 4 is a second view (top view) showing a state of vehicle photographing by the photographing system 1. With reference to FIGS. 3 and 4, the recognition camera 13 photographs an identification moving image from an angle (first angle) at which the license plate can be photographed. In the example, the identification moving image is photographed from almost the front of the vehicle 9. On the other hand, the viewing camera 14 photographs the viewing moving image from an angle (second angle) at which the photography is good (so-called SNS looking good).

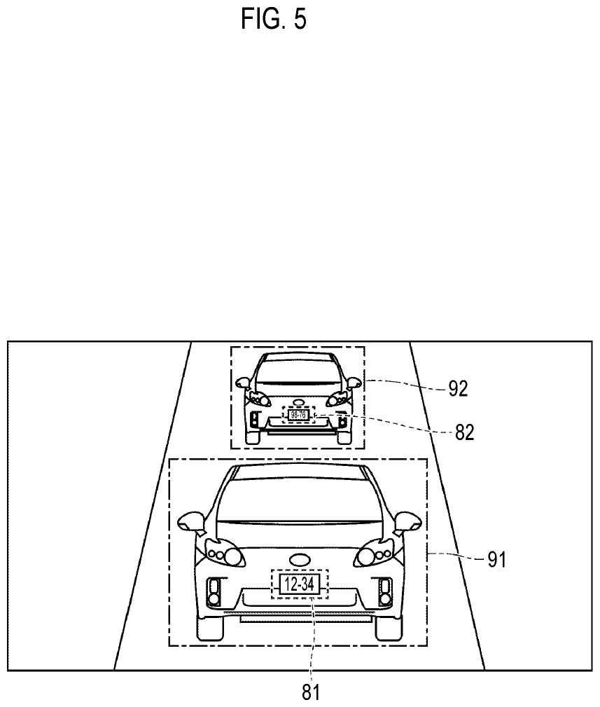

FIG. 5 is a diagram showing an example of one frame of the identification moving image. As shown in FIG. 5, a plurality of vehicles 9 (91, 92) may be reflected in the identification moving image. Hereinafter, among the vehicles, the vehicle to be photographed (the vehicle for which the viewing image is to be photographed) is described as “target vehicle”, and the target vehicle is distinguished from other vehicles.

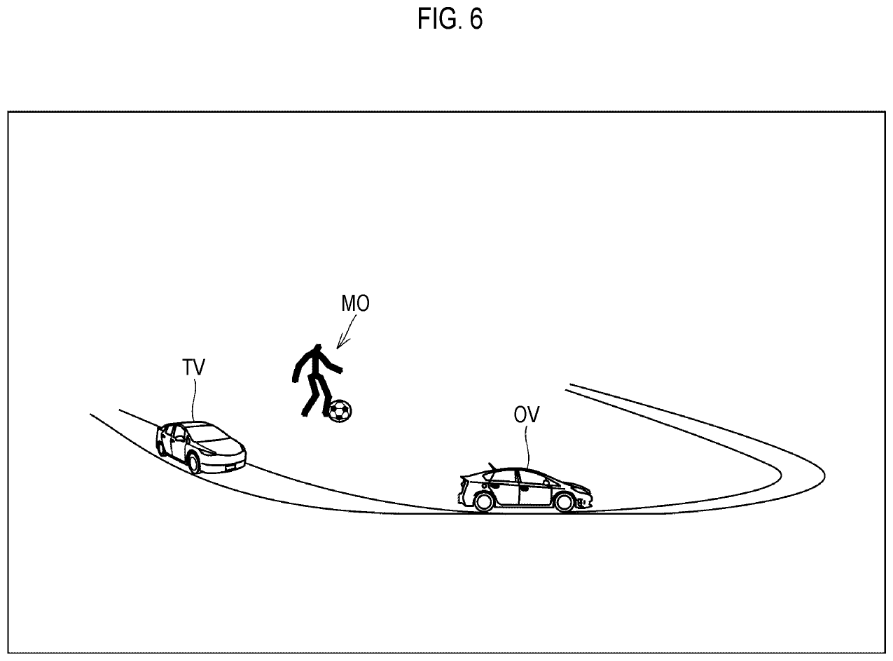

FIG. 6 is a diagram showing an example of one frame of the viewing moving image. For the viewing moving image, it is not needed that the license plate of the target vehicle is reflected. However, the license plate of the target vehicle may be reflected in the viewing moving image.

In the example shown in FIG. 6, a monument MO of humankind, a U-shaped road, a target vehicle TV traveling on the road, and the other vehicle OV are reflected.

The target vehicle TV and the other vehicle OV are not limited to the four-wheeled vehicles as shown in FIGS. 3 to 6, and may be, for example, a two-wheeled vehicle (a motorcycle). Since the license plate of the two-wheeled vehicle is attached merely to the rear, it is easy to have a situation in which the license plate cannot be photographed.

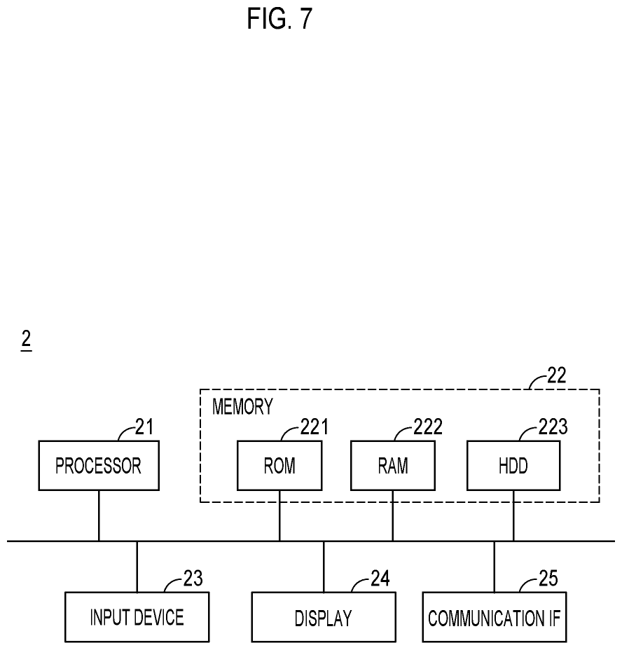

FIG. 7 is a block diagram showing a typical hardware configuration of the server 2. The server 2 includes a processor 21, a memory 22, an input device 23, a display 24, and a communication IF 25. The memory 22 includes a ROM 221, a RAM 222, and an HDD 223. The components of the server 2 are connected to each other by a bus and the like.

The processor 21 executes various arithmetic processing on the server 2. The memory 22 stores a program executed by the processor 21 and data used in the program. Further, the memory 22 stores data used for image processing by the server 2 and stores image-processed data by the server 2. The input device 23 receives the input of the administrator of the server 2. The input device 23 is typically a keyboard and a mouse. The display 24 displays various information. The communication IF 25 is an interface to communicate with the photographing system 1.

Functional Configuration of Image Processing System

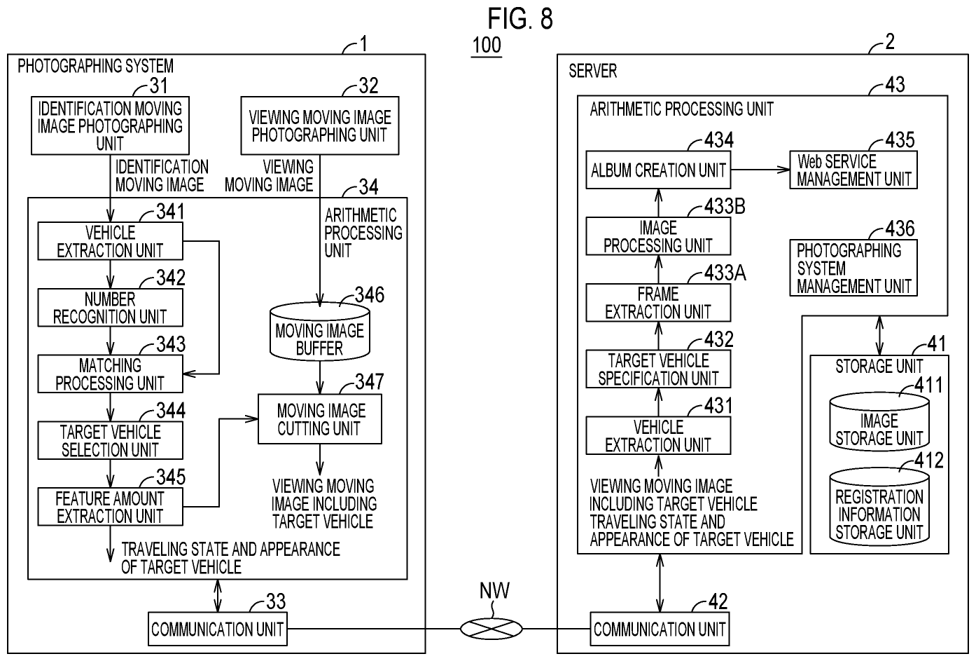

FIG. 8 is a functional block diagram showing a functional configuration of the photographing system 1 and the server 2. The photographing system 1 includes an identification moving image photographing unit 31, a viewing moving image photographing unit 32, a communication unit 33, and an arithmetic processing unit 34. The arithmetic processing unit 34 includes a vehicle extraction unit 341, a number recognition unit 342, a matching processing unit 343, a target vehicle selection unit 344, a feature amount extraction unit 345, a moving image buffer 346, and a moving image cutting unit 347.

The identification moving image photographing unit 31 photographs an identification moving image for the number recognition unit 342 to recognize the number of the license plate. The identification moving image photographing unit 31 outputs the identification moving image to the vehicle extraction unit 341. The identification moving image photographing unit 31 corresponds to the recognition camera 13 of FIG. 2.

The viewing moving image photographing unit 32 photographs the viewing moving image for the user to view of the vehicle 9. The viewing moving image photographing unit 32 outputs the viewing moving image to the moving image buffer 346. The viewing moving image photographing unit 32 corresponds to the viewing camera 14 shown in FIG. 2.

The communication unit 33 performs bidirectional communication with a communication unit 42 (described later) of the server 2 via the network NW. The communication unit 33 receives the number of the target vehicle from the server 2. Further, the communication unit 33 transmits a viewing moving image (more specifically, a moving image cut out from the viewing moving image to include the target vehicle) to the server 2. The communication unit 33 corresponds to the communication IF 15 of FIG. 2.

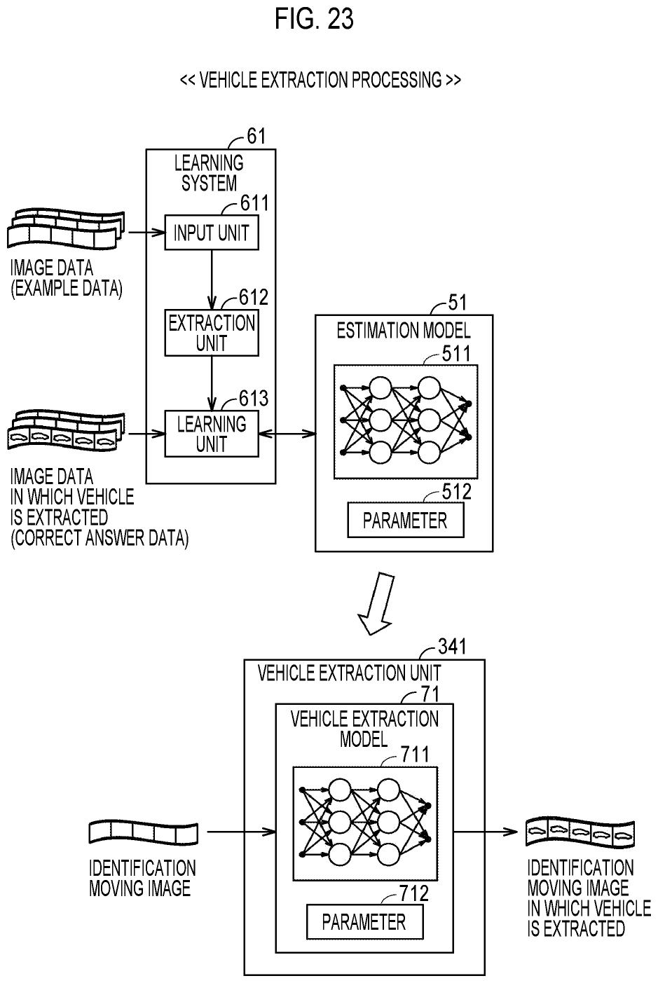

The vehicle extraction unit 341 extracts a vehicle (including the entire vehicles, not limited to the target vehicle) from the identification moving image. The processing is also referred to as “vehicle extraction processing”. For the vehicle extraction processing, for example, a trained model generated by a machine learning technique such as deep learning (deep layer learning) can be used. In the example, the vehicle extraction unit 341 is realized by a “vehicle extraction model”. The vehicle extraction model will be described with reference to FIG. 23. The vehicle extraction unit 341 outputs a moving image (a frame including the vehicle) in which the vehicle is extracted from the identification moving image to the number recognition unit 342 and outputs the moving image to the matching processing unit 343.

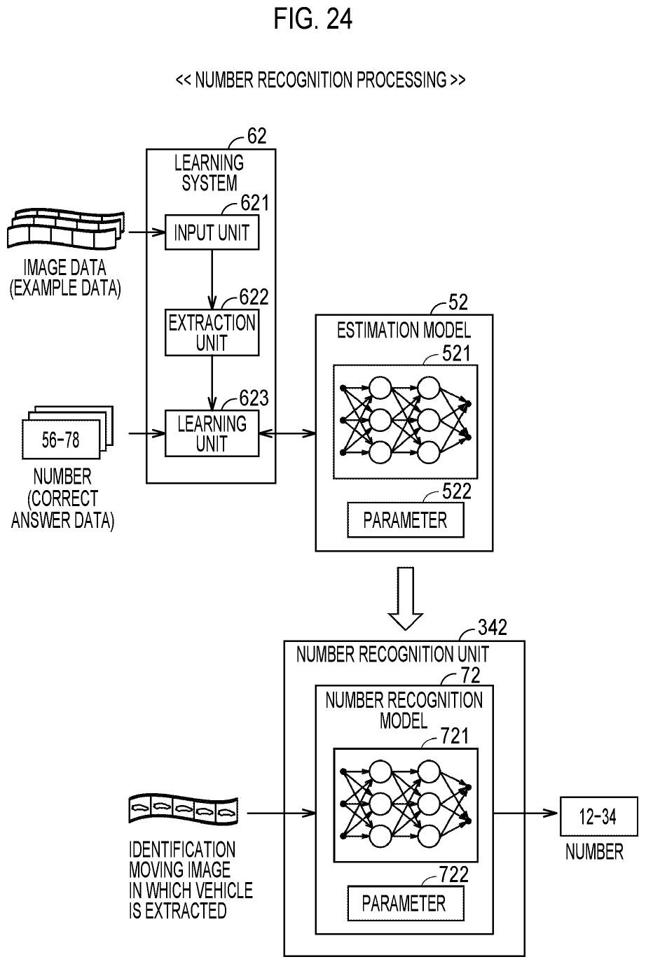

The number recognition unit 342 recognizes the number of the license plate from the moving image in which the vehicle is extracted by the vehicle extraction unit 341. The processing is also referred to as “number recognition processing”. A trained model generated by a machine learning technique such as deep learning can also be used for the number recognition processing. In the example, the number recognition unit 342 is realized by the “number recognition model”. The number recognition model will be described with reference to FIG. 24. The number recognition unit 342 outputs the recognized number to the matching processing unit 343. Further, the number recognition unit 342 outputs the recognized number to the communication unit 33. As a result, the number of each vehicle is transmitted to the server 2.

The matching processing unit 343 associates the vehicle extracted by the vehicle extraction unit 341 with the number recognized by the number recognition unit 342. The processing is also referred to as “matching processing”. Specifically, with reference to FIG. 5 again, a situation in which the two vehicles 91, 92 are extracted and two numbers 81, 82 are recognized will be described as an example. The matching processing unit 343 calculates the distance between the number and the vehicle (the distance between the coordinates of the number and the coordinates of the vehicle on the frame) for each number. Then, the matching processing unit 343 matches the number with the vehicle having a short distance from the number. In the example, since the distance between the number 81 and the vehicle 91 is shorter than the distance between the number 81 and the vehicle 92, the matching processing unit 343 associates the number 81 with the vehicle 91. Similarly, the matching processing unit 343 associates the number 82 with the vehicle 92. The matching processing unit 343 outputs the result of the matching processing (vehicle to which the number is associated) to the target vehicle selection unit 344.

The target vehicle selection unit 344 selects a vehicle of which number matches the number of the target vehicle (received from the server 2) as the target vehicle from the vehicles to which the numbers are associated by the matching processing. The target vehicle selection unit 344 outputs the vehicle selected as the target vehicle to the feature amount extraction unit 345.

The feature amount extraction unit 345 extracts the feature amount of the target vehicle by analyzing the moving image including the target vehicle. More specifically, the feature amount extraction unit 345 calculates the traveling speed of the target vehicle based on the temporal change of the target vehicle in the frame including the target vehicle (for example, the movement amount of the target vehicle between the frames, and the change amount of the size of the target vehicle between the frames). The feature amount extraction unit 345 may calculate, for example, the acceleration (deceleration) of the target vehicle in addition to the traveling speed of the target vehicle. Further, the feature amount extraction unit 345 extracts information on the appearance (body shape, body color, and the like) of the target vehicle by using a known image recognition technique. The feature amount extraction unit 345 outputs the feature amount (traveling state and appearance) of the target vehicle to the moving image cutting unit. Further, the feature amount extraction unit 345 outputs the feature amount of the target vehicle to the communication unit 33. As a result, the feature amount of the target vehicle is transmitted to the server 2.

The moving image buffer 346 temporarily stores the viewing moving image. The moving image buffer 346 is typically a ring buffer (circular buffer), and has an annular storage area in which the beginning and the end of the one-dimensional array are logically connected. The newly photographed viewing moving image is stored in the moving image buffer 346 for a predetermined time that can be stored in the storage area. The viewing moving image (old moving image) that exceeds the predetermined time is automatically deleted from the moving image buffer 346.

The moving image cutting unit 347 cuts out the portion in which the target vehicle is likely to be photographed based on the feature amount (a traveling speed, an acceleration, a body shape, a body color, and the like of the target vehicle) extracted by the feature amount extraction unit 345 from the viewing moving image stored in the moving image buffer 346. More specifically, the distance between the point photographed by the identification moving image photographing unit 31 (the recognition camera 13) and the point photographed by the viewing moving image photographing unit 32 (the viewing camera 14) is known. Therefore, when the traveling speed (and acceleration) of the target vehicle is known, the moving image cutting unit 347 can calculate the time difference between a timing at which the target vehicle is photographed by the identification moving image photographing unit 31 and a timing at which the target vehicle is photographed by the viewing moving image photographing unit 32. The moving image cutting unit 347 calculates the timing at which the target vehicle is photographed by the viewing moving image photographing unit 32 based on the timing at which the target vehicle is photographed by the identification moving image photographing unit 31 and the time difference. Then, the moving image cutting unit 347 cuts out a moving image having a predetermined time width (for example, several seconds to several tens of seconds) including the timing at which the target vehicle is photographed from the viewing moving image stored in the moving image buffer 346. The moving image cutting unit 347 outputs the cut-out viewing moving image to the communication unit 33. As a result, the viewing moving image including the target vehicle is transmitted to the server 2.

The moving image cutting unit 347 may cut out the viewing moving image at a predetermined timing regardless of the feature amount extracted by the feature amount extraction unit 345. That is, the moving image cutting unit 347 may cut out the viewing moving image photographed by the viewing moving image photographing unit 32 after a predetermined time difference from the timing when the target vehicle is photographed by the identification moving image photographing unit 31.

The server 2 includes a storage unit 41, the communication unit 42, and an arithmetic processing unit 43. The storage unit 41 includes an image storage unit 411 and a registration information storage unit 412. The arithmetic processing unit 43 includes a vehicle extraction unit 431, a target vehicle specification unit 432, a frame extraction unit 433A, an image processing unit 433B, an album creation unit 434, a web service management unit 435, and a photographing system management unit 436.

The image storage unit 411 stores the final image obtained as a result of the arithmetic processing by the server 2. More specifically, the image storage unit 411 stores the images before and after processing by the frame extraction unit 433A and the image processing unit 433B, and stores the album created by the album creation unit 434.

The registration information storage unit 412 stores registration information related to a vehicle photographing service. The registration information includes the personal information of the user who applied for the provision of the vehicle photographing service and the vehicle information of the user. The personal information of the user includes, for example, information related to the identification number (ID), the name, the date of birth, the address, the telephone number, and the e-mail address of the user. The vehicle information of the user includes information related to the number of the license plate of the vehicle. The vehicle information may include, for example, information related to a vehicle kind, a model year, a body shape (a sedan kind, a wagon kind, and a one-box kind), and a body color.

The communication unit 42 performs bidirectional communication with the communication unit 33 of the photographing system 1 via the network NW. The communication unit 42 transmits the number of the target vehicle to the photographing system 1. Further, the communication unit 42 receives the viewing moving image including the target vehicle and the feature amount (a traveling state and appearance) of the target vehicle from the photographing system 1. The communication unit 42 corresponds to the communication IF 25 of FIG. 7.

The vehicle extraction unit 431 extracts a vehicle (including the entire vehicles, not limited to the target vehicle) from the viewing moving image. For the processing, a vehicle extraction model can be used in the same manner as the vehicle extraction processing by the vehicle extraction unit 341 of the photographing system 1. The vehicle extraction unit 431 outputs a moving image (a frame including the vehicle) in which the vehicle is extracted from the viewing moving image to the target vehicle specification unit 432.

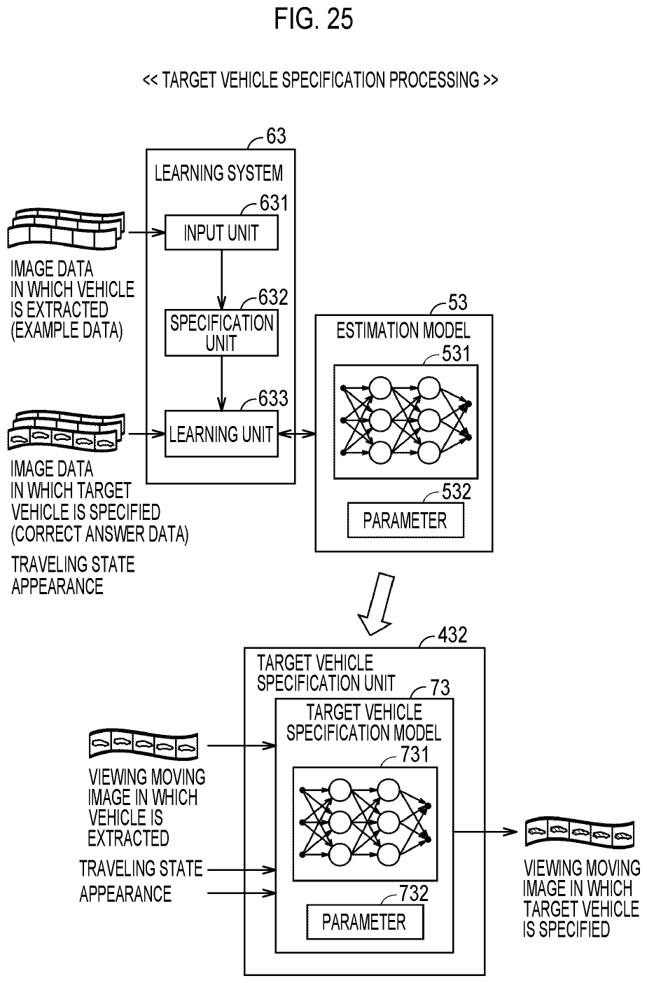

The target vehicle specification unit 432 specifies the target vehicle based on the feature amount of the target vehicle (that is, a traveling state such as a traveling speed and an acceleration, and the appearance such as a body shape and a body color) from the vehicle extracted by the vehicle extraction unit 431. The processing is also referred to as “target vehicle specification processing”. A trained model generated by a machine learning technique such as deep learning can also be used for the target vehicle specification processing. In the example, the target vehicle specification unit 432 is realized by the “target vehicle specification model”. The target vehicle specification model will be described with reference to FIG. 25. By specifying the target vehicle by the target vehicle specification unit 432, at least one viewing image is generated. The viewing image usually includes a plurality of images (a plurality of frames that is continuous in time).

The frame extraction unit 433A extracts an image (frame) in which the target vehicle is positioned at a predetermined specific position from the viewing image output from the target vehicle specification unit 432. The processing is also referred to as frame extraction processing. The specific position is not limited to one, and may be set to a plurality of points.

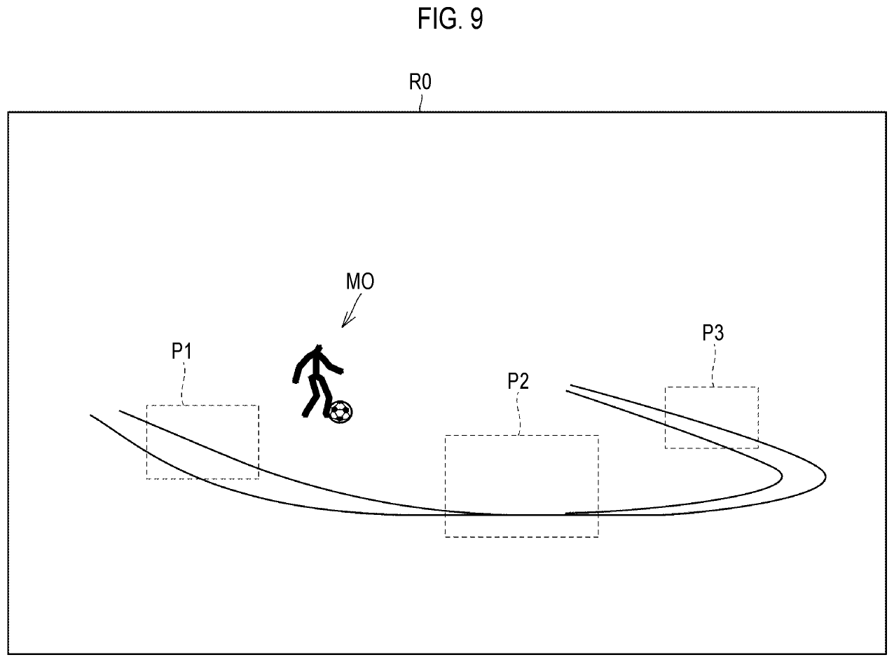

FIG. 9 is a diagram schematically showing specific positions P1, P2, P3 in one frame of a moving image photographed by the viewing moving image photographing unit 32. In the frame, a plurality of specific positions P1, P2, P3 is set.

An imaging range R0 of the viewing moving image photographing unit 32 is fixed, and the specific positions P1, P2, P3 are predetermined positions within the imaging range R0.

The viewing image output by the target vehicle specification unit 432 to the frame extraction unit 433 includes image data of each frame, and position information of the target vehicle and information indicating a range occupied by the target vehicle in each frame. The frame extraction unit 433A determines whether the target vehicle is positioned at any of the specific positions P1, P2, P3 in each frame based on the position information of the target vehicle and the range occupied by the target vehicle included in each frame.

For the specific positions P1, P2, P3, for example, the specific positions P1, P2, P3 can be determined by performing verification in advance on which position makes a traveling posture of the target vehicle look aesthetically pleasing. In particular, when the imaging range R0 of the viewing moving image photographing unit 32 is fixed, the traveling posture of the target vehicle at the specific positions P1, P2, P3, and the like can be grasped in advance, and thus the specific positions P1, P2, P3 can be determined by performing verification in advance. The specific position may be one point.

The good traveling posture includes the posture of the vehicle having a dynamic feeling of cornering and the posture of the vehicle having a feeling of speed when the vehicle travels in a straight line. The posture of the vehicle with a dynamic feeling of cornering includes the posture when entering the corner, the posture during cornering, the posture when the vehicle exits the corner, and the like.

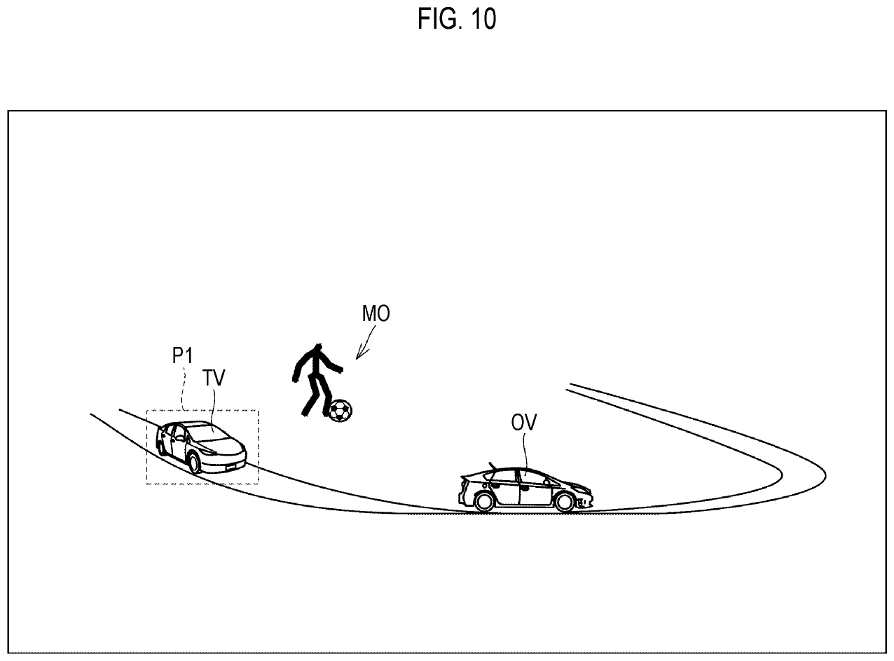

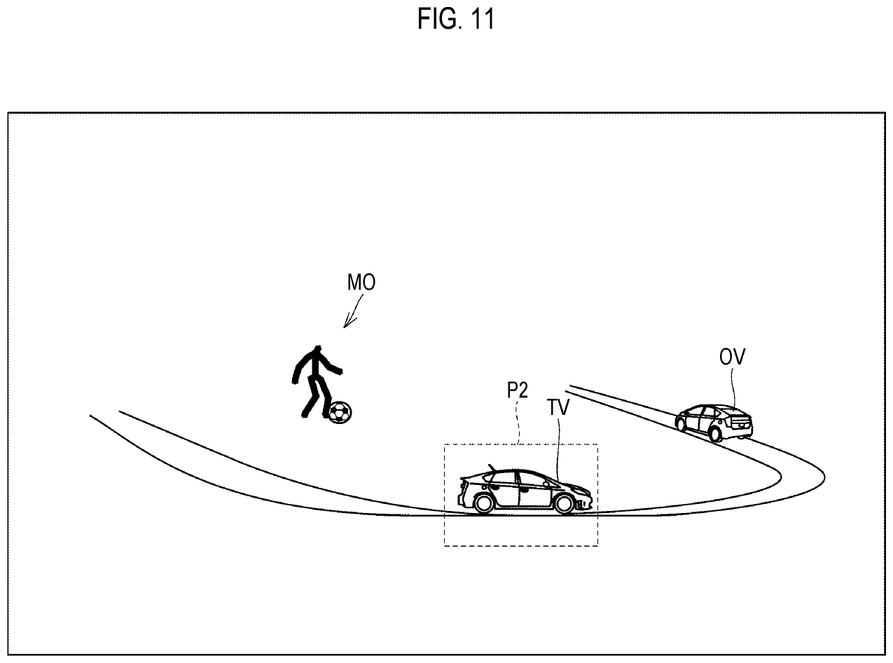

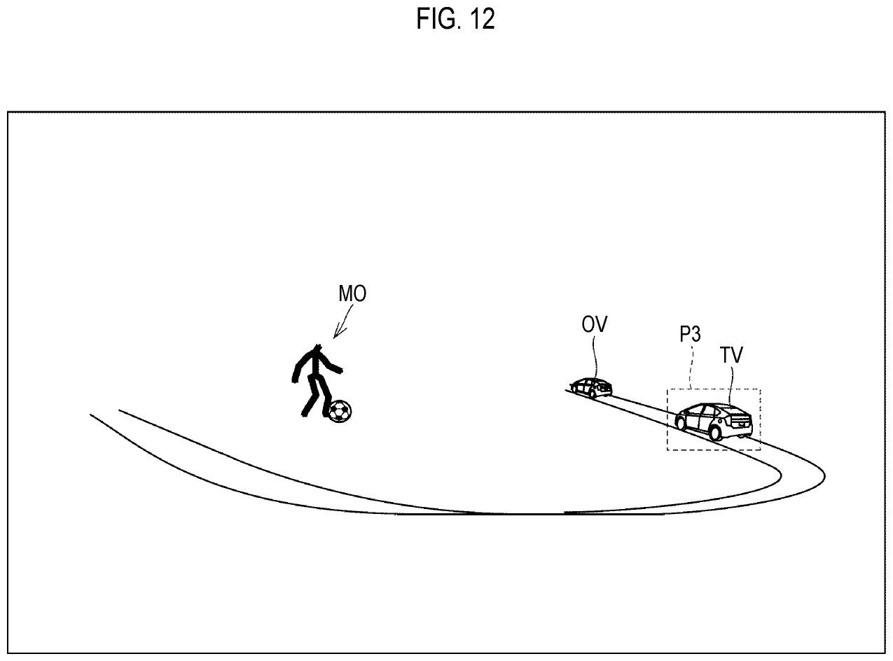

FIG. 10 is an extraction image IM1 in which the target vehicle is positioned at the specific position P1. FIG. 11 is an extraction image IM2 in which the target vehicle is positioned at the specific position P2. FIG. 12 is an extraction image IM3 in which the target vehicle is positioned at the specific position P3. In the present embodiment, the frame extraction unit 433A extracts the extraction images IM1 to IM3.

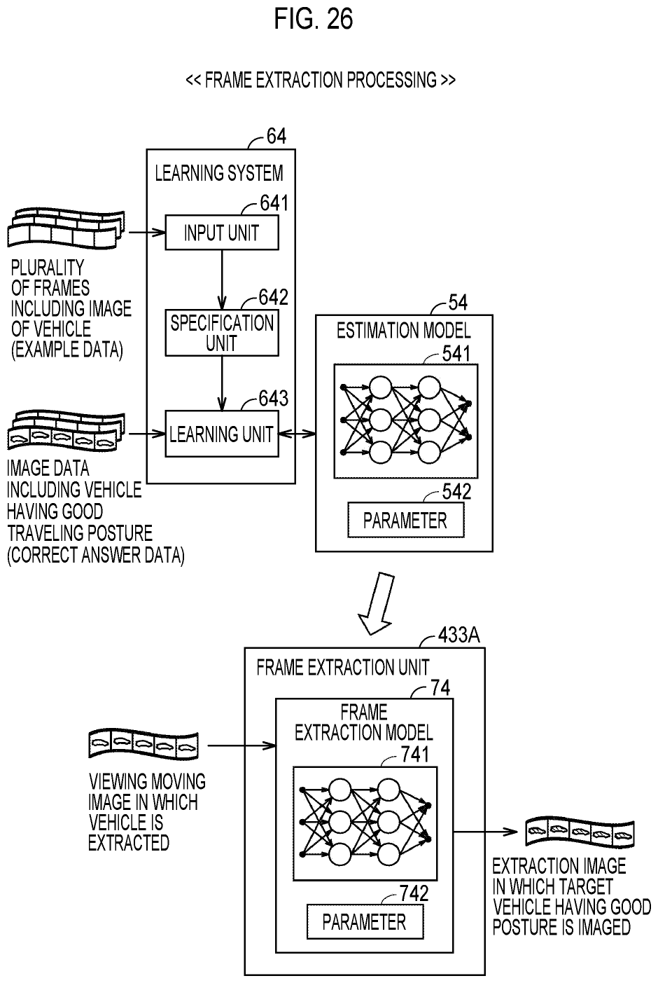

For the frame extraction processing, for example, a trained model (frame extraction model) generated by a machine learning technique such as deep learning (deep layer learning) can be used. The “frame extraction model” will be described later in FIG. 26.

The extraction images IM1, IM2, IM3 shown in FIGS. 10 to 12 show the target vehicle TV, the other vehicle OV, and the monument MO.

The frame extraction unit 433A outputs at least one extraction image (extracted frame) extracted to the image processing unit 433B. In the present embodiment, the extraction images IM1, IM2, IM3 are output to the image processing unit 433B.

The image processing unit 433B crops the extraction image such that the cropped image includes the target vehicle TV. The processing is called vehicle cropping processing.

In the vehicle cropping processing, the range occupied by the target vehicle TV and the range occupied by the surrounding other than the target vehicle are determined in the extraction image.

Then, for example, based on the rule of thirds, the target vehicle TV and the surrounding image other than the target vehicle are cropped from the extraction image. In this way, by performing the vehicle cropping processing, the final image using the rule of thirds is acquired. The composition rule is not limited to the rule of thirds, and various composition rules such as the rule of fourths, the triangle composition, and the center composition may be adopted.

When the vehicle cropping processing is performed, the background included in the surrounding image, and the like may be taken into consideration. For example, when the image processing unit 433B determines that the surrounding image includes an image such as the other vehicle OV, the image processing unit 433B performs the vehicle cropping processing such that the cropped image does not include an exclusion target such as the other vehicle.

In the case, the image processing unit 433B detects an object around the target vehicle TV by using an object detection model such as you only look once (YOLO). Then, the image processing unit 433B specifies an exclusion target such as the other vehicle OV, and performs the vehicle cropping processing on the extraction image such that the exclusion target is not included in the cropped image.

When the vehicle cropping processing is performed, the cropped image may include a specific background in the surrounding image. For example, the cropped image may include a specific background such as the sea and the mountain in the background.

When the imaging range R0 of the viewing moving image photographing unit 32 is fixed, the position of the target to be included (inclusion target) as the background is fixed.

In the case, the image processing unit 433B acquires information indicating the position and the range of the inclusion target in advance. Then, in the vehicle cropping processing, the cropped image includes the target vehicle TV and the inclusion target and does not include the exclusion target, and the extraction image is cropped such that the target vehicle TV is positioned in the cropped image based on the rule of thirds and the like. An object and the like recognized as an inclusion target by the object detection model may be cropped to be included as the inclusion target.

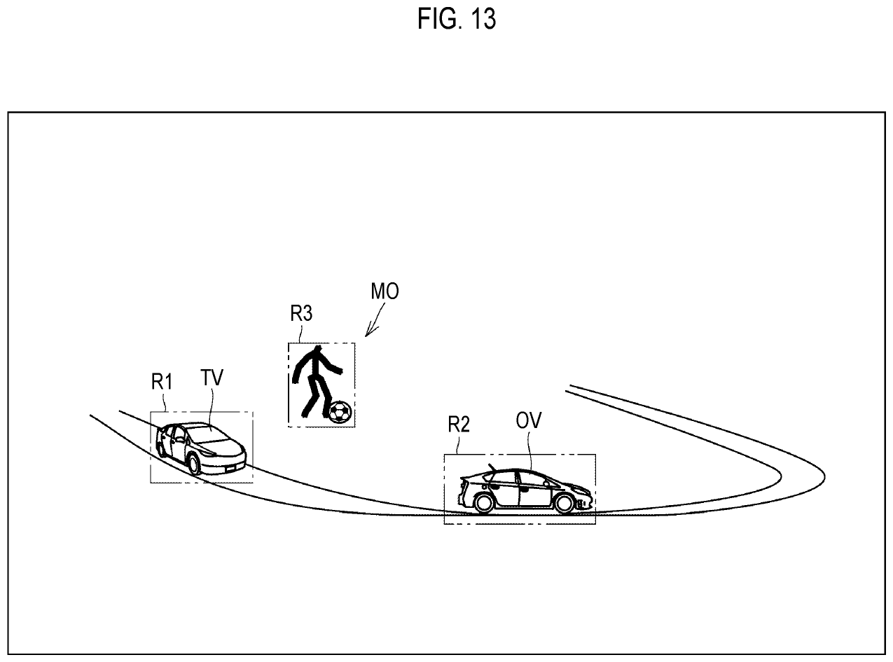

FIG. 13 is the extraction image IM1 schematically showing a result of analysis by using the object detection model. In FIG. 13, the target range R1 indicates the range occupied by the target vehicle TV. The exclusion range R2 indicates the range occupied by the other vehicle OV. The inclusion range R3 indicates the range occupied by the monument MO. In FIG. 13, the other vehicle OV is illustrated as the exclusion target, but the exclusion target includes an image of a person who can be specified by an individual, a nameplate of a house, and the like. Further, although the monument MO is illustrated as the inclusion target, for example, a conspicuous building and a tree may be included.

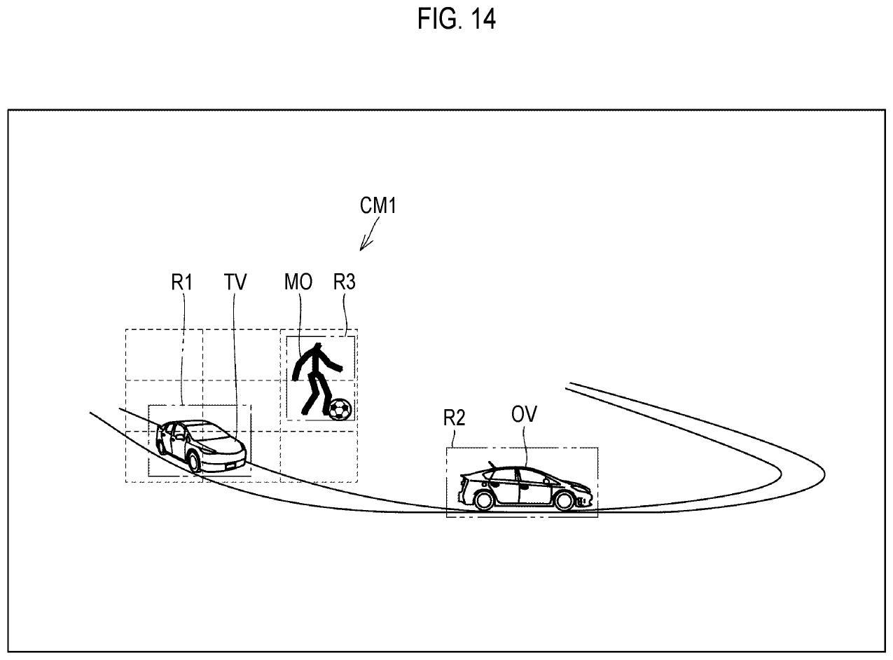

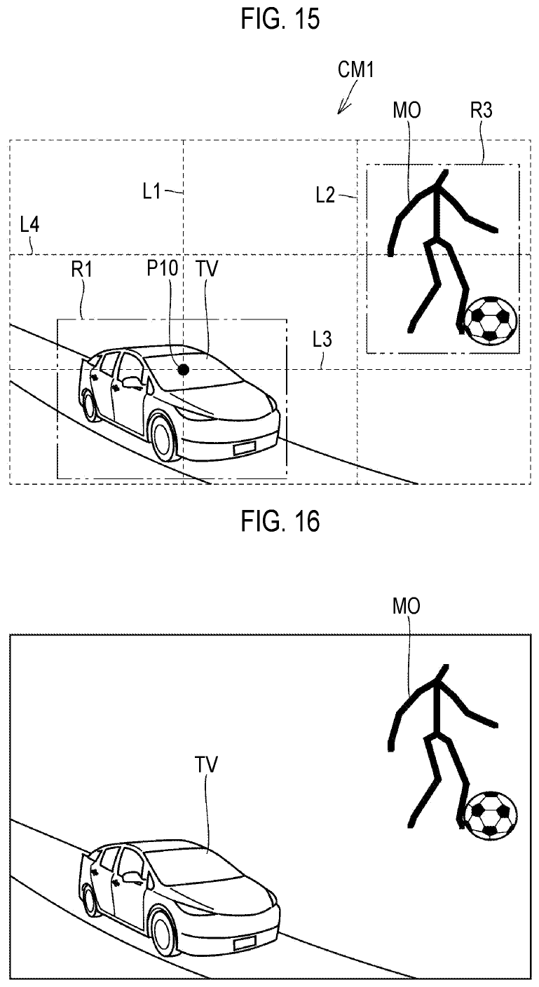

FIG. 14 is a diagram schematically showing a state in which the rule of thirds map CM1 is superimposed on the extraction image IM1 showing a target range R1 and the like. FIG. 15 is a diagram showing the rule of thirds map CM1 and the like.

Since the target vehicle TV faces diagonally forward when the target vehicle TV is positioned at the specific position P1, the image processing unit 433B adopts the rule of thirds map CM1.

The image processing unit 433B superimposes the rule of thirds map CM1 on the extraction image IM1. The rule of thirds map CM1 has a rectangular shape, and the rule of thirds map CM1 includes an outline of a rectangular shape, vertical division lines L1, L2, and horizontal division lines L3, L4.

The image processing unit 433B adjusts the size of the rule of thirds map CM1 such that the target range R1 and the inclusion range R3 are included in the rule of thirds map CM1 and the exclusion range R2 is not included. Further, the image processing unit 433B disposes the rule of thirds map CM1 such that an intersection P10 of the vertical division line L1 and the horizontal division line L3 is positioned within the target range R1. Then, the image processing unit 433B crops the extraction image IM1 along the outer shape of the rule of thirds map CM1. In this way, the image processing unit 433B can create the extraction image IM1 by performing the vehicle cropping processing on the extraction image IM1.

FIG. 16 is a diagram showing the final image FIM1. According to the final image FIM1, based on the rule of thirds, the target vehicle TV can be contained in the image, and the monument MO can be contained in the image. In the final image FIM1, the other vehicle OV can be excluded.

Although described based on the extraction image EVIL the image processing unit 433B also performs the vehicle cropping processing on the extraction image IM2 and the extraction image IM3.

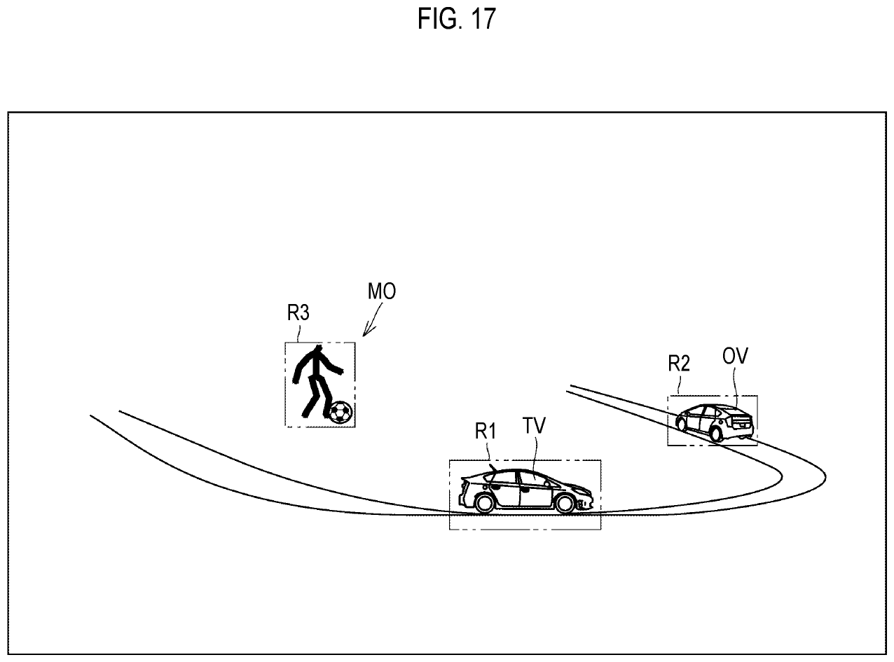

FIG. 17 is the extraction image IM2 schematically showing the result of analysis using the object detection model. The image processing unit 433B also sets the target range R1, the exclusion range R2, and the inclusion range R3 in the extraction image IM2.

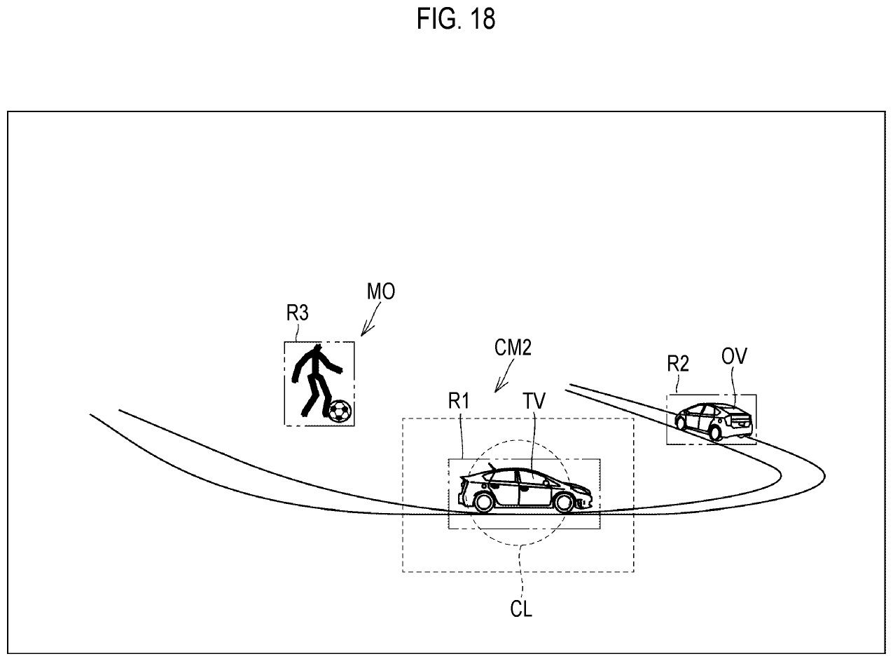

FIG. 18 is a diagram showing a state in which the center composition map CM2 is superimposed on the extraction image IM2 showing the target range R1 and the like. The center composition map CM2 includes an outline of a rectangular shape and a virtual circle CL. The virtual circle CL is positioned in the center of the center composition map CM2.

The image processing unit 433B installs the center composition map CM2 such that the center of the target range R1 is positioned in the virtual circle CL.

In the state in which the target vehicle TV is positioned at the specific position P2, the target vehicle TV faces directly to the side. Therefore, the image processing unit 433B selects the center composition map CM2 as the composition map. In this way, when the specific position is specified in advance, the composition map to be adopted is changed according to the specific position.

In FIG. 18, when the inclusion range R3 is to be included in the center composition map CM2, the exclusion range R2 is included in the center composition map CM2, and thus the image processing unit 433B sets the center composition map CM2 such that merely the target range R1 is included in the center composition map CM2. Then, the image processing unit 433B crops the extraction image IM2 along the outer shape of the center composition map CM2. In this way, the image processing unit 433B can create the final image FIM2 by performing the vehicle cropping processing on the extraction image IM2.

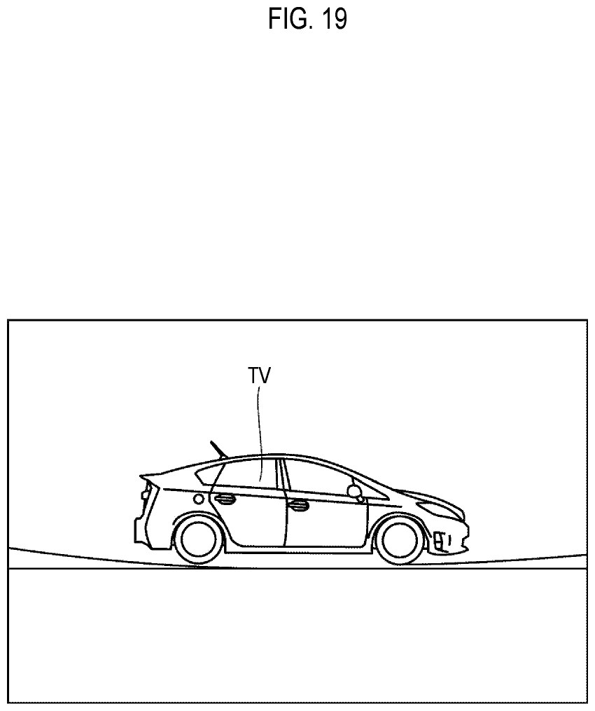

FIG. 19 is a diagram schematically showing the final image FIM2. According to the final image FIM2, an image to which the center composition is applied can be acquired. Further, an image that does not include the other vehicle OV that is an exclusion target can be acquired.

In the extraction image IM2 of the vehicle positioned at the specific position P2 also, the image of the target vehicle TV may be cropped by using the rule of thirds map CM1 and the like.

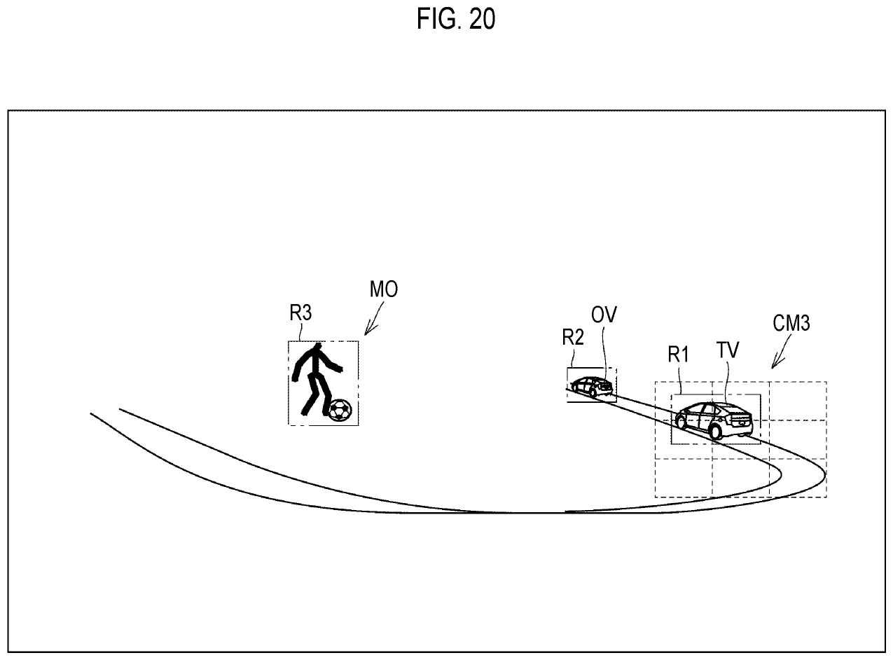

FIG. 20 is a diagram showing a state in which the rule of thirds map CM3 is superimposed on the extraction image IM3 while the extraction image IM3 is analyzed by using the object detection model.

The image processing unit 433B selects the rule of thirds map CM3 because the target vehicle TV positioned at the specific position P3 faces diagonally.

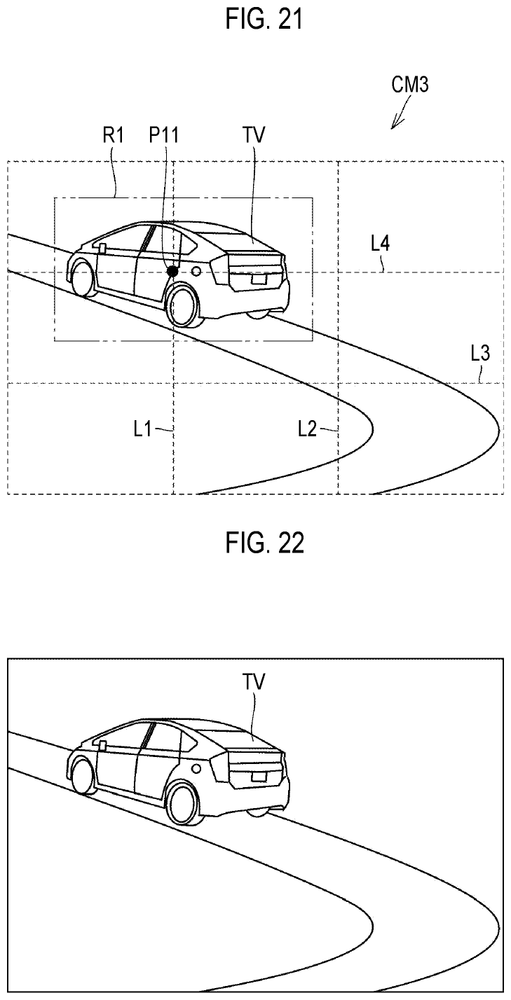

FIG. 21 is a diagram showing the rule of thirds map CM3 and the like. Then, the rule of thirds map CM3 is disposed such that an intersection P11 at which the vertical division line L1 and the horizontal division line L4 of the rule of thirds map CM3 intersect and the target range R1 overlap.

Then, the image processing unit 433B adjusts the size of the rule of thirds map CM1 such that the target range R1 and the inclusion range R3 are included in the rule of thirds map CM3 and the exclusion range R2 is not included. In the example shown in FIG. 21, when the rule of thirds map CM3 is set such that the target range R1 and the inclusion range R3 are included, the exclusion range R2 is included. Therefore, the image processing unit 433B sets the rule of thirds map CM3 such that merely the target range R1 is positioned in the rule of thirds map CM3.

Then, the image processing unit 433B can create the final image FIM3 by cropping the extraction image IM3 along the outer shape of the rule of thirds map CM3.

FIG. 22 is a diagram showing the final image FIM3. In this way, the image using the rule of thirds can be acquired. The image processing unit 433B sets the cropping range such that the number of pixels in the cropping range is not smaller than the preset number of pixels. The above-mentioned is because when the number of pixels is too small, the image of the target vehicle TV is unclear in the final image as a result. Further, the cropping range is set such that the ratio occupied by the target range R1 in the cropping range is larger than a predetermined value. The above-mentioned is to suppress the target vehicle TV from being too small in the final image FIM3.

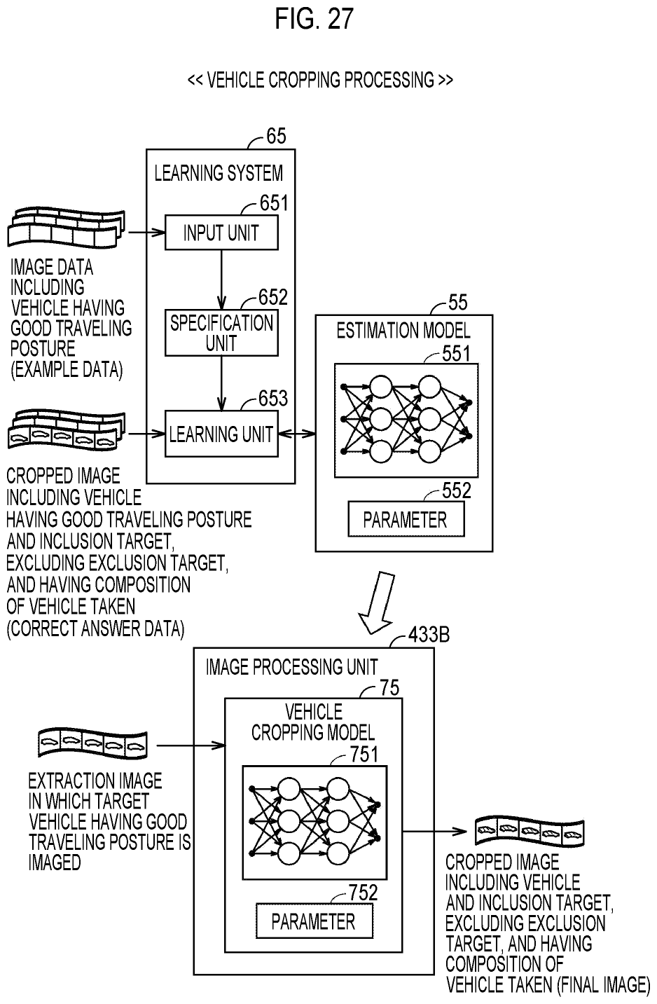

For the vehicle cropping processing, for example, a trained model (vehicle cropping model) generated by a machine learning technique such as deep learning (deep layer learning) can be used. The “vehicle cropping model” will be described later in FIG. 27.

Returning to FIG. 8, the image processing unit 433B outputs the final images FIM1 to FIM3 to the album creation unit 434. The album creation unit 434 creates an album using the final image. A known image analysis technique (for example, a technique for automatically creating a photo book and a slide show from the images photographed by a smartphone) can be used for creating an album. The album creation unit 434 outputs the album to the web service management unit 435.

The web service management unit 435 provides a web service (for example, an application program that can be linked to the SNS) by using an album created by the album creation unit 434. The web service management unit 435 may be implemented on a server different from the server 2.

The photographing system management unit 436 manages (monitors and diagnoses) the photographing system 1. When some abnormality (camera failure, communication failure, and the like) occurs in the photographing system 1 under management, the photographing system management unit 436 notifies the administrator of the server 2 of the abnormality. As a result, the administrator can take measures such as inspection and repair of the photographing system 1. The photographing system management unit 436 may be implemented as a separate server as well as the web service management unit 435.

Trained Model

FIG. 23 is a diagram for describing an example of a trained model (vehicle extraction model) used in the vehicle extraction processing. An estimation model 51, which is a pre-learning model, includes, for example, a neural network 511 and a parameter 512. The neural network 511 is a known neural network used for image recognition processing by deep learning. Examples of such a neural network include a convolution neural network (CNN) and a recurrent neural network (RNN). The parameter 512 includes a weighting coefficient and the like used in the calculation by the neural network 511.

A large amount of training data is prepared in advance by a developer. The training data includes example data and correct answer data. The example data is image data including the vehicle that is an extraction target. The correct answer data includes the extraction result corresponding to the example data. Specifically, the correct answer data is image data in which the vehicle included in the example data is extracted.

A learning system 61 trains the estimation model 51 by using the example data and the correct answer data. The learning system 61 includes an input unit 611, an extraction unit 612, and a learning unit 613.

The input unit 611 receives a large number of example data (image data) prepared by the developer and outputs the example data to the extraction unit 612.

By inputting the example data from the input unit 611 into the estimation model 51, the extraction unit 612 extracts the vehicle included in the example data for each example data. The extraction unit 612 outputs the extraction result (the output from the estimation model 51) to the learning unit 613.

The learning unit 613 trains the estimation model 51 based on the extraction result of the vehicle from the example data received from the extraction unit 612 and the correct answer data corresponding to the example data. Specifically, the learning unit 613 adjusts the parameter 512 (for example, a weighting coefficient) such that the extraction result of the vehicle obtained by the extraction unit 612 approaches the correct answer data.

The estimation model 51 is learned as described above, and the estimation model 51 for which the learning is completed is stored in the vehicle extraction unit 341 (and the vehicle extraction unit 431) as the vehicle extraction model 71. The vehicle extraction model 71 receives the identification moving image as an input and outputs the identification moving image in which the vehicle is extracted. For each frame of the identification moving image, the vehicle extraction model 71 outputs the extracted vehicle to the matching processing unit 343 in association with the identifier of the frame. The frame identifier is, for example, a timestamp (the time information of the frame).

FIG. 24 is a diagram for describing an example of a trained model (number recognition model) used in the number recognition processing. The example data is image data including a number to be recognized. The correct answer data is data indicating the position and number of the license plate included in the example data. Although the example data and the correct answer data are different, the learning method of the estimation model 52 by the learning system 62 is the same as the learning method by the learning system 61 (see FIG. 9), and thus the detailed description is not repeated.

The estimation model 52 for which learning is completed is stored in the number recognition unit 342 as a number recognition model 72. The number recognition model 72 receives the identification moving image in which the vehicle is extracted by the vehicle extraction unit 341 as an input, and outputs the coordinates and the number of the license plate. For each frame of the identification moving image, the number recognition model 72 outputs the coordinates and the number of the recognized license plate to the matching processing unit 343 in association with the identifier of the frame.

FIG. 25 is a diagram for describing an example of a trained model (target vehicle specification model) used in target vehicle specification processing. The example data is image data including a target vehicle that is a specific target. The example data further includes information related to the feature amount (specifically, a traveling state and appearance) of the target vehicle. The correct answer data is image data in which the target vehicle included in the example data is specified. Since the learning method of the estimation model 53 by the learning system 63 is also the same as the learning method by the learning systems 61, 62 (see FIGS. 23 and 24), the detailed description is not repeated.

The estimation model 53 for which learning is completed is stored in the target vehicle specification unit 432 as the target vehicle specification model 73. The target vehicle specification model 73 receives the viewing moving image in which the vehicle is extracted by the vehicle extraction unit 431 and the feature amount (a traveling state and appearance) of the target vehicle as inputs, and outputs the viewing moving image in which the target vehicle is specified. For each frame of the viewing moving image, the target vehicle specification model 73 outputs the specified viewing moving image to the frame extraction unit 433A in association with the identifier of the frame.

The vehicle extraction processing is not limited to the processing using machine learning. A known image recognition technique (an image recognition model and an algorithm) that does not use machine learning can be applied to the vehicle extraction processing. The same also applies to the number recognition processing and the target vehicle specification processing.

FIG. 26 is a diagram for describing an example of a trained model (frame extraction model) that extracts a frame.

The example data is a plurality of image frames including the vehicle to be recognized. The correct answer data includes the extraction result corresponding to the example data. Specifically, the correct answer data is an image frame in which the vehicle having a good traveling posture is reflected from a plurality of image frames of the example data.

Although the example data and the correct answer data are different, the learning method of the estimation model 54 by the learning system 64 is the same as the learning method by the learning system 61 and the like, and thus the detailed description is not repeated.

The estimation model 54 for which learning is completed is stored in the frame extraction unit 433A as the frame extraction model 74. The frame extraction model 74 receives the viewing moving image in which the target vehicle is specified as an input, and outputs the frame in which the target vehicle having a good traveling posture is imaged as an extraction image to the image processing unit 433B.

The frame extraction processing is not limited to the processing using machine learning. A known image recognition technique (an image recognition model and an algorithm) that does not use machine learning can be applied to the frame extraction processing. FIG. 27 is a diagram for describing an example of a trained model (vehicle cropping model) that crops the extraction image.

The example data is a plurality of image frames including the vehicle to be recognized. The image frame of the example data desirably includes at least one of the exclusion target and the inclusion target. The correct answer data is a cropped image cropped from the example data. Specifically, the cropped image obtained by cropping the example data such that the cropped image includes a vehicle to be recognized and an inclusion target and excludes the exclusion target.

In a case where the exclusion target is included when the correct answer data includes the inclusion target, the correct answer data includes the image cropped to include the vehicle to be recognized without including the inclusion target and the exclusion target. Further, the correct answer data includes an image in which the cropping range is set such that the number of pixels in the cropping range is equal to or greater than a predetermined number. The correct answer data includes an image that is set such that the range occupied by the vehicle to be recognized within the cropping range is equal to or greater than a predetermined range. The cropped image of the correct answer data is a cropped image obtained by cropping the example data to apply various composition rules such as a rule of thirds, a rule of fourths, a triangle composition, and a center composition.

Although the example data and the correct answer data are different, the learning method of the estimation model 54 by the learning system 64 is the same as the learning method by the learning system 61 and the like, and thus the detailed description is not repeated.

The estimation model 52 for which learning is completed is stored in the image processing unit 433B as the vehicle cropping model 75.

The vehicle cropping model 75 receives an extraction image (frame) in which a target vehicle having a good traveling posture is imaged as an input, and outputs a cropped image to which the composition rule is applied as a final image. The vehicle cropping processing is not limited to the processing using machine learning. A known image recognition technique (an image recognition model and an algorithm) that does not use machine learning can be applied to the vehicle cropping processing.

Processing Flow

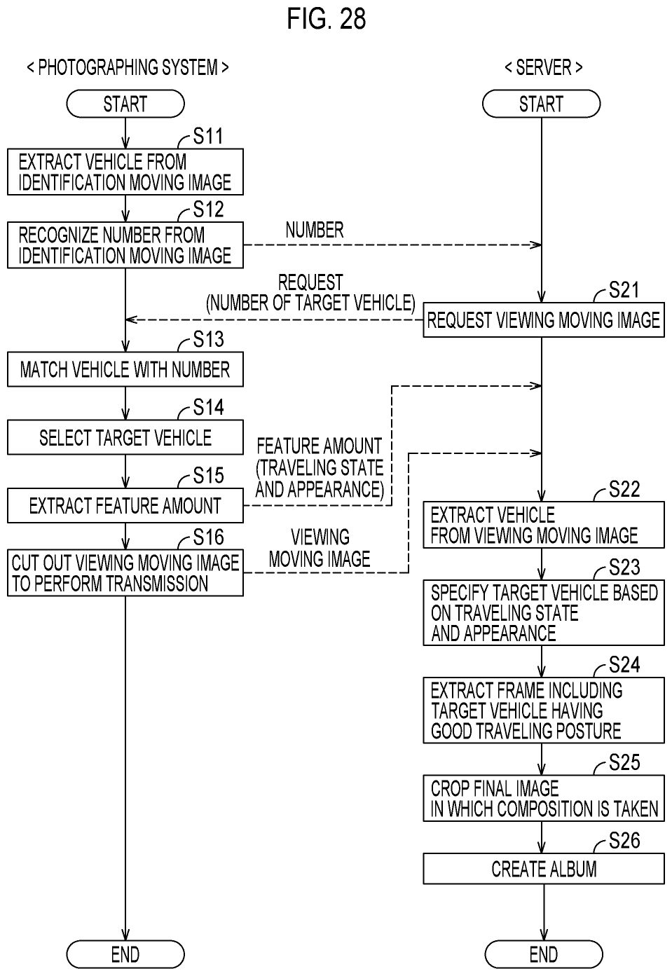

FIG. 28 is a flowchart showing a processing procedure of photographing processing of the vehicle according to the present embodiment. The flowchart is performed, for example, when a predetermined condition is satisfied or at a predetermined cycle. In the figure, the processing by the photographing system 1 is shown on the left side, and the processing by the server 2 is shown on the right side. Each step is realized by software processing by the processor 11 or the processor 21, but may be realized by hardware (electric circuit). Hereinafter, step is abbreviated as S.

In step S11, the photographing system 1 extracts a vehicle by executing the vehicle extraction processing (see FIG. 9) for the identification moving image. Further, the photographing system 1 recognizes the number by executing the number recognition processing (see FIG. 10) on the identification moving image in which the vehicle is extracted (step S12). The photographing system 1 transmits the recognized number to the server 2.

When the server 2 receives the number from the photographing system 1, the server 2 refers to registration information to determine whether the received number is a registered number (that is, whether the vehicle photographed by the photographing system 1 is the vehicle (target vehicle) of the user who applied for the provision of the vehicle photographing service). When the received number is a registered number (the number of the target vehicle), the server 2 transmits the number of the target vehicle and requests the photographing system 1 to transmit the viewing moving image including the target vehicle (step S21).

In step S13, the photographing system 1 executes matching processing between each vehicle and each number in the recognition moving image. Then, the photographing system 1 selects a vehicle, with which the same number as the number of the target vehicle is associated, as the corresponding vehicle from the vehicles with which the numbers are associated (step S14). Further, the photographing system 1 extracts the feature amount (a traveling state and appearance) of the target vehicle, and transmits the extracted feature amount to the server 2.

In step S16, the photographing system 1 cuts out a portion including the target vehicle from the viewing moving image temporarily stored in the memory 22 (the moving image buffer 346). In the cutting out, the traveling state (a traveling speed, an acceleration, and the like) and appearance (a body shape, a body color, and the like) of the target vehicle can be used as described above. The photographing system 1 transmits the cut-out viewing moving image to the server 2.

In step S22, the server 2 extracts the vehicle by executing the vehicle extraction processing (see FIG. 9) for the viewing moving image received from the photographing system 1.

In step S23, the server 2 specifies the target vehicle from the vehicles extracted in step S22 based on the feature amount (a traveling state and appearance) of the target vehicle (the target vehicle specification processing in FIG. 11). It is also conceivable to use merely one of the traveling state and the appearance of the target vehicle as the feature amount of the target vehicle. Note that, the viewing moving image may include a plurality of vehicles having the same body shape and body color, or may include a plurality of vehicles having almost the same traveling speed and acceleration. On the other hand, in the present embodiment, although the plurality of vehicles having the same body shape and body color is included in the viewing moving image, the target vehicle can be distinguished from the other vehicle when the traveling speed and/or the acceleration is different among the vehicles. Alternatively, although the plurality of vehicles with almost the same traveling speed and acceleration is included in the viewing moving image, the target vehicle can be distinguished from the other vehicle when the body shape and/or the body color is different among the vehicles. In this way, by using both the traveling state and the appearance of the target vehicle as the feature amount of the target vehicle, the specification precision of the target vehicle can be improved.

Note that, it is not obligatory to use both the traveling state and the appearance of the target vehicle, and merely one of the traveling state and the appearance may be used. Information related to the traveling state and/or the appearance of the target vehicle corresponds to the “target vehicle information” according to the present disclosure. Further, the information related to the appearance of the target vehicle may be the vehicle information stored in advance in the registration information storage unit 412 as well as the vehicle information obtained by the analysis by the photographing system 1 (the feature amount extraction unit 345).

In step S24, the server 2 extracts at least one extraction image (extracted frame) in which the target vehicle TV having a good traveling posture is imaged from the viewing moving image (a plurality of viewing images) including the target vehicle.

In step S25, the server 2 performs cropping on the extraction image such that the target vehicle is included and a predetermined composition is obtained, and extracts the final image including the target vehicle. In step S25, cropping is performed such that the exclusion target is not included. When the exclusion target is not included, the server 2 performs cropping such that the inclusion target is included. In a case where the exclusion target is included when the inclusion target is included, the server 2 performs cropping such that the inclusion target and the exclusion target are not included. The server 2 performs cropping such that the number of pixels in the cropping range is equal to or greater than a predetermined number. The server 2 performs cropping such that the range occupied by the vehicle to be recognized is equal to or greater than a predetermined range within the cropping range.

Then, the server 2 creates an album using the final image (step S26). The user can view the created album and post the desired image in the album to the SNS.

In the present embodiment, an example in which the photographing system 1 and the server 2 share and execute image processing is described. Therefore, both the processor 11 of the photographing system 1 and the processor 21 of the server 2 correspond to the “processor” according to the present disclosure. However, the photographing system 1 may execute all the image processing and transmit the image-processed data (viewing image) to the server 2. Therefore, the server 2 is not an obligatory component for the image processing according to the present disclosure. In the case, the processor 11 of the photographing system 1 corresponds to the “processor” according to the present disclosure. Alternatively, conversely, the photographing system 1 may transmit all the photographed moving images to the server 2, and the server 2 may execute all the image processing. In the case, the processor 21 of the server 2 corresponds to the “processor” according to the present disclosure.

An image processing system according to the present disclosure includes a memory configured to store moving image data photographed by a camera, and a processor configured to perform image processing on the moving image data stored in the memory, extract a plurality of frames in which a target vehicle registered in advance is imaged from a moving image photographed by the camera, and select a frame in which the target vehicle is positioned at a specific position among the frames.

In the image processing system, the imaging range of the camera may be fixed, and the specific position may be a predetermined position in the imaging range.

The image processing system may include a first model storage memory storing a frame extraction model. The frame extraction model may be a trained model that receives a plurality of frames in which a vehicle is imaged as an input and outputs a frame in which a traveling posture of the vehicle is good, and the processor may be configured to select a frame in which the traveling posture of the target vehicle is good from the frames as a frame in which the target vehicle is positioned at the specific position by using the frame extraction model.

In the image processing system, the processor may be configured to perform cropping the frame in which the target vehicle is positioned at the specific position such that a composition of the target vehicle and a background image is a predetermined composition.

The image processing system may further include a second model storage memory storing a cropping model. The cropping model may be a trained module that receives the frame in which the target vehicle is imaged as an input and that outputs a cropped image obtained by cropping the received frame into an image that includes the target vehicle and to which a composition rule is applied

In the image processing system according to the present disclosure, an attractive image of a traveling vehicle can be acquired.

The embodiments disclosed in the present disclosure should be considered to be exemplary and not restrictive in any respects. The scope of the present disclosure is set forth by the claims rather than the description of the embodiments, and is intended to include all modifications within the meaning and scope of the claims.

What is claimed is:

1. An image processing system comprising:
a memory configured to store moving image data photographed by a camera; and
a processor configured to
perform image processing on the moving image data stored in the memory,
extract a plurality of frames in which a target vehicle registered in advance is imaged from a moving image photographed by the camera, and
select a frame in which the target vehicle is positioned at a specific position among the frames.

2. The image processing system according to claim 1, wherein:
an imaging range of the camera is fixed; and
the specific position is a predetermined position in the imaging range.

3. The image processing system according to claim 1, further comprising a first model storage memory storing a frame extraction model, wherein:
the frame extraction model is a trained model that receives the frames in which a vehicle is imaged as an input and outputs a frame in which a traveling posture of the vehicle is good; and
the processor is configured to select a frame in which the traveling posture of the target vehicle is good from the frames as the frame in which the target vehicle is positioned at the specific position by using the frame extraction model.

4. The image processing system according to claim 1, wherein the processor is configured to perform cropping the frame in which the target vehicle is positioned at the specific position such that a composition of the target vehicle and a background image is a predetermined composition.

5. The image processing system according to claim 1, further comprising a second model storage memory storing a cropping model,
wherein the cropping model is a trained module that receives the frame in which the target vehicle is imaged as an input and that outputs a cropped image obtained by cropping the received frame into an image that includes the target vehicle and to which a composition rule is applied.
